(19) United States
(12) Patent Application Publication
(10) Pub. No.: US 2016/0370393 A1
(43) Pub. Date: Dec. 22, 2016

(54) ROBOT, CONTROL APPARATUS, AND CONTROL METHOD

(71) Applicant: Seiko Epson Corporation, Tokyo (JP)

(72) Inventors: Tomoki HARADA, Matsumoto (JP); Takashi NAMMOTO, Azumino (JP); Kenichi MARUYAMA, Tatsuno (JP)

(21) Appl. No.: 15/182,908

(22) Filed: Jun. 15, 2016

(30) Foreign Application Priority Data
Jun. 16, 2015 (JP) 2015-120868

(51) Int. Cl. G01N 35/00; B25J 9/16

(52) U.S. Cl. CPC G01N 35/0099; B25J 9/1612; Y10S 901/31

(57) ABSTRACT

A robot includes a first arm, and a first end effector provided in the first arm, and the first end effector grasps a container and an object is spread within the container using a spreading member.

### BACKGROUND

1. Technical Field

The present invention relates to a robot, a control apparatus, and a control method.

2. Related Art

Recent advancement of industrial robots has been remarkable and robots that can execute various kinds of work that had been difficult for robots of related art have been developed. In recent years, in addition to scalar robots or six-axis single-arm robots of related art, effort has been put into dual-arm robots. Further, for example, effort has been put into robots that execute work requiring special jigs or work that had been performed by human hand. Particularly, it has been required to replace work in environments desired to avoid human hand, the so-called 3K (Kiken (danger), Kitanai (dirty), Kitsui (hard)) environments or environments in which chemicals and bacteria dangerous to the human body with work of robots.

Patent Document 1 (JP-A-2012-117878) discloses a specimen processing system that executes processing including predetermined steps on a specimen and has a robot including a base and an arm having a plurality of joint parts and a plurality of processing apparatuses provided within a movable range of the arm for performing the processing on the specimen (see Patent Document 1). For example, Patent Document 1 discloses that work is performed by a dual-arm robot using a petri dish, a spatula, a pipette, or the like.

However, in the robots of related art, the work using chemicals often requires a special technology and may be hard to be realized by simple operation of the robots. For example, special work such as the dilution plate technique is considered to be difficult in the robot disclosed in Patent Document 1 even when impedance control is performed and the spatula is operated by a hand.

### SUMMARY

An advantage of some aspects of the invention is to provide a robot, a control apparatus, and a control method that may perform spreading of chemicals or the like.

An aspect of the invention is directed to a robot including a first arm, and a first end effector provided in the first arm, wherein the first end effector grasps a container and an object is spread within the container using a spreading member.

According to this configuration, in the robot, the first end effector provided in the first arm grasps the container and the object is spread within the container using the spreading member. Thereby, in the robot, spreading of chemicals or the like may be performed.

The aspect of the invention may be configured such that the robot further includes a second arm.

According to this configuration, in the robot, work can be performed using the second arm. Thereby, in the robot, spreading of chemicals or the like may be performed while work is performed using the second arm.

The aspect of the invention may be configured such that the robot further includes a second end effector provided in the second arm, and the second end effector grasps the spreading member.

According to this configuration, in the robot, the second end effector provided in the second arm grasps the spreading member. Thereby, in the robot, spreading of chemicals or the like may be performed while the spreading member is grasped.

The aspect of the invention may be configured such that the robot further includes a second end effector provided in the second arm, and the second end effector includes the spreading member.

According to this configuration, in the robot, the second end effector provided in the second arm includes the spreading member. Thereby, in the robot, the spreading member may be provided and spreading of chemicals or the like may be performed.

The aspect of the invention may be configured such that, in the robot, an end of the spreading member is movable relatively to an end of the second arm.

According to this configuration, in the robot, the end of the spreading member is movable relatively to the end of the second arm. Thereby, in the robot, spreading of chemicals or the like may be performed while the end of the spreading member is moved relatively to the end of the second arm.

The aspect of the invention may be configured such that in the robot, the spreading member applies a force to such an extent that an agar medium is not destroyed.

According to this configuration, in the robot, the spreading member applies a force to such an extent that the agar medium is not destroyed. Thereby, in the robot, spreading of chemicals or the like may be performed by the spreading member with a force to such an extent that the agar medium is not destroyed.

The aspect of the invention may be configured such that, in the robot, work of a dilution plate technique or work equivalent thereto can be performed.

According to this configuration, in the robot, the work of the dilution plate technique or the work equivalent thereto can be performed. Thereby, in the robot, spreading of chemicals or the like may be performed in the work of the dilution plate technique or the work equivalent thereto.

The aspect of the invention may be configured such that, in the robot, when the first armor the first end effector grasps the container, the container can be rotated about an axis perpendicular to a bottom surface of the container.

According to this configuration, in the robot, when the first arm or the first end effector grasps the container, the container can be rotated about the axis perpendicular to the bottom surface of the container. Thereby, in the robot, spreading of chemicals or the like may be performed while the container is rotated.

The aspect of the invention may be configured such that, in the robot, an end of the spreading member moves with a motion of the first arm.

According to this configuration, in the robot, the end of the spreading member moves with the motion of the first arm. Thereby, in the robot, spreading of chemicals or the like may be performed while the first arm is moved to move the end of the spreading member.

Another aspect of the invention is directed to a control apparatus of a robot including a first arm and a first end effector provided in the first arm, the control apparatus performing control of grasping a container by the first end effector and spreading an object within the container using a spreading member.

According to this configuration, in the control apparatus, the container is grasped by the first end effector provided in the first arm of the robot and the object is spread within the container using the spreading member. Thereby, in the control apparatus, spreading of chemicals or the like may be performed by the robot.

Still another aspect of the invention is directed to a control method of a robot including a first arm and a first end effector provided in the first arm, the method including performing control of grasping a container by the first end effector and spreading an object within the container using a spreading member.

According to this configuration, in the control method, the container is grasped by the first end effector provided in the first arm of the robot and the object is spread within the container using the spreading member. Thereby, in the control method, spreading of chemicals or the like may be performed in the robot.

As described above, according to the robot, the control apparatus, and the control method according to an aspect of the invention, the container is grasped by the first end effector provided in the first arm of the robot and the object is spread within the container using the spreading member. Thereby, in the robot, the control apparatus, and the control method, spreading of chemicals or the like may be performed in the robot.

### BRIEF DESCRIPTION OF THE DRAWINGS

The invention will be described with reference to the accompanying drawings, wherein like numbers reference like elements.

FIG. 1 shows a schematic configuration example of a robot and a processing apparatus according to one embodiment of the invention.

FIG. 2 shows an example of a schematic configuration of a second end effector of the robot according to one embodiment of the invention.

FIG. 3 shows another example of a schematic configuration of a second end effector of the robot according to one embodiment of the invention.

FIG. 4 is a block diagram showing a schematic configuration example of a control apparatus according to one embodiment of the invention.

FIG. 5 shows an example of a spreading motion performed by the robot according to one embodiment of the invention.

FIG. 6 shows an image of rotation of a first end effector according to one embodiment of the invention.

FIG. 7 shows an image of linear movement of the first end effector according to one embodiment of the invention.

FIGS. 8A, 8B, 8C show images of inclinations of the first end effector according to one embodiment of the invention.

FIG. 9 shows a schematic configuration example of a robot system according to one embodiment of the invention.

### DESCRIPTION OF EXEMPLARY EMBODIMENTS

Embodiments of the invention will be explained in detail with reference to the drawings.

### First Embodiment

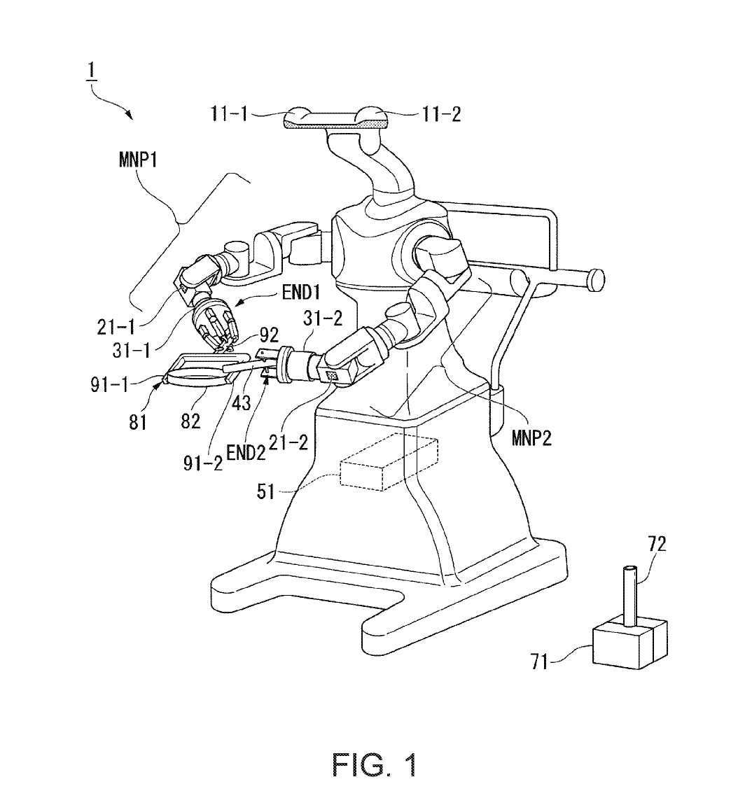

FIG. 1 shows a schematic configuration example of a robot 1 and a processing apparatus according to one embodiment of the invention.

The robot 1 is explained.

The robot 1 includes a head part on the upside, a trunk part at the center, a base part on the downside, and arm parts provided on the trunk part.

The robot 1 is a dual-arm robot having two arms as arm parts. Each arm has a plurality of joints.

As a configuration on one arm side, the robot 1 includes a first manipulator MNP1 (an example of an arm), a first force sensor 31-1, and a first end effector END1. They are integrated and, in the embodiment, the first force sensor 31-1 is provided between the first manipulator MNP1 and the first end effector END1.

As a configuration on the other arm side, the robot 1 includes a second manipulator MNP2 (an example of the arm), a second force sensor 31-2, and a second end effector END2. They are integrated and, in the embodiment, the second force sensor 31-2 is provided between the second manipulator MNP2 and the second end effector END2.

In the embodiment, a motion at a degree of freedom of seven axes can be performed by the configuration on the one arm side (the manipulator MNP1 with the end effector END1 attached thereto), and a motion at a degree of freedom of seven axes can be performed by the configuration on the other arm side (the manipulator MNP2 with the end effector END2 attached thereto). As another configuration example, a configuration that performs a motion at a degree of freedom of six axes or less or eight axes or more may be used.

Here, when the arm moves at the degree of freedom of seven axes, the number of attitudes that may be taken is larger than that in the case where the arm moves at the degree of freedom of six axes or less, and thereby, for example, the motion becomes smoother and interference with an object existing around the arm may be easily avoided. Further, when the arm moves at the degree of freedom of seven axes, control of the arm is easier because the amount of calculation is smaller than those in the case where the arm moves at the degree of freedom of eight axes or more. On this account, in the embodiment, the arm moving at the degree of freedom of seven axes is used as a preferable example.

Furthermore, in the embodiment, the trunk part is a waist part and has a configuration that can rotate at a degree of freedom of one axis.

The robot 1 includes two imaging units (first imaging unit 11-1, second imaging unit 11-2) respectively provided on the left and the right of the head part, an imaging unit (third imaging unit 21-1) provided in a predetermined part of the first manipulator MNP1, and an imaging unit (fourth imaging unit 21-2) provided in a predetermined part of the second manipulator MNP2.

Each of the imaging units (the first imaging unit 11-1, the second imaging unit 11-2, the third imaging unit 21-1, the fourth imaging unit 21-2) is a camera using e.g. CCD (Charge Coupled Device), CMOS (Complementary Metal Oxide Semiconductor), or the like.

The first imaging unit 11-1 and the second imaging unit 11-2 are respectively moved in response to the motion of the head part.

The third imaging unit 21-1 and the fourth imaging unit 21-2 are respectively moved in response to the respective motions of the first manipulator MNP1 and the second manipulator MNP2.

Further, the robot 1 includes a control apparatus 51. In the embodiment, the robot 1 includes the control apparatus 51 within the base part.

The control apparatus 51 controls the motion of the robot 1. The control apparatus 51 controls the motions of e.g. the first manipulator MNP1 and the second manipulator MNP2. Further, in the configuration in which the motion of a part of the waist or the like of the robot 1 can be performed, the control apparatus 51 controls the motion of the part of the waist or the like.

In the embodiment, each of the first imaging unit 11-1, the second imaging unit 11-2, the third imaging unit 21-1, the fourth imaging unit 21-2 captures an image and transmits (outputs) information of the captured image to the control apparatus 51. Further, each of the first force sensor 31-1 and the second force sensor 31-2 detects a force and moment acting on each of the first end effector END1 and the second end effector END2, and transmits (outputs) information of the detection results to the control apparatus 51. The control apparatus 51 can receive (input) the information and use the received information when controlling the motion of the robot 1.

Here, each of the first imaging unit 11-1, the second imaging unit 11-2, the third imaging unit 21-1, the fourth imaging unit 21-2, the first force sensor 31-1, and the second force sensor 31-2 and the control apparatus 51 are connected via a line and can communicate information via the line.

In the embodiment, calibration of a coordinate system is performed with respect to a position and an attitude of the first manipulator MNP1, a position and an attitude of the second manipulator MNP2, and images captured by the respective imaging units (the first imaging unit 11-1, the second imaging unit 11-2, the third imaging unit 21-1, the fourth imaging unit 21-2).

In the embodiment, the control apparatus 51 controls the motion of the robot 1 according to a motion control program set in advance. The control apparatus 51 teaches various kinds of information necessary for realization of the motion of the robot 1 to the robot 1 (main body).

The second end effector END2 of the robot 1 will be explained.

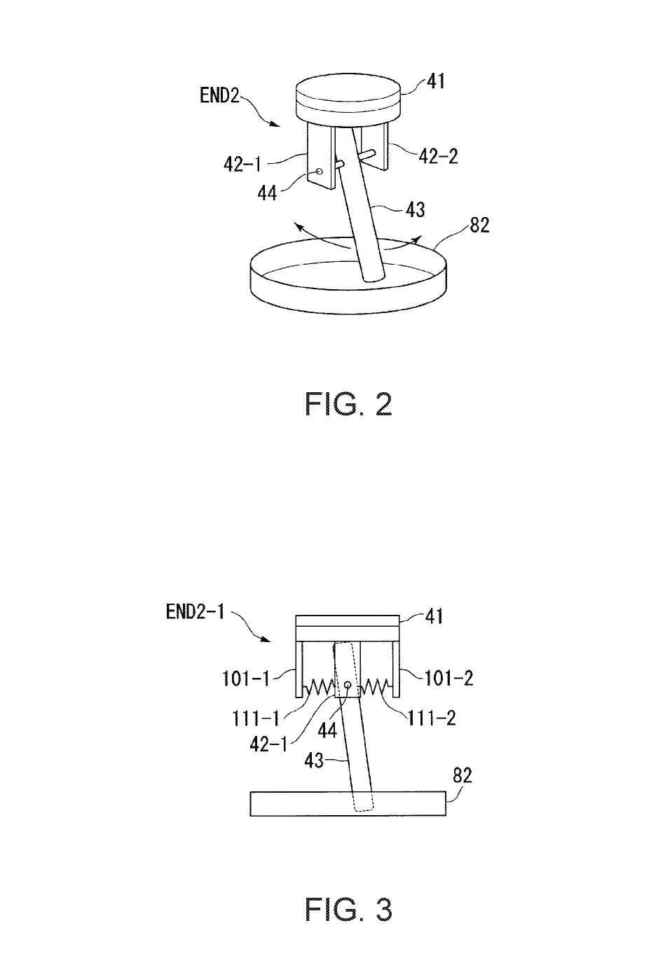

FIG. 2 shows an example of a schematic configuration of the second end effector END2 of the robot according to one embodiment of the invention. FIG. 2 also shows a petri dish 82 as an example of a container.

The second end effector END2 includes a base member 41, two members 42-1, 42-2, and a glass rod 43. The base member 41 has a circular plate shape (or cylinder shape), and one surface is connected to the second manipulator MNP2 and the two members 42-1, 42-2 are provided on the other surface. The two members 42-1, 42-2 have rectangular (e.g. oblong) plate shapes and are provided on the same surface of the base member 41 at a predetermined distance so that these plate surfaces may face each other. Each of the two members 42-1, 42-2 has a supporting portion 44 that rotatably supports the glass rod 43.

In the embodiment, the supporting portions 44 are hole portions formed in the positions opposed to each other in the respective two members 42-1, 42-2. The glass rod 43 has projecting portions projecting outward in positions symmetric with each other near one end. Further, one projecting portion of the glass rod 43 is rotatably fitted in the hole portion of one member 42-1 and the other projecting portion of the glass rod 43 is rotatably fitted in the hole portion of the other member 42-2. According to the configuration, the part near the end of the glass rod 43 is sandwiched between the two members 42-1, 42-2 and rotatably supported by the supporting portions 44 of the two members 42-1, 42-2. Thereby, in the second end effector END2, the glass rod 43 can rotate to draw an arc like a pendulum about a line connecting the supporting portions 44 of the two members 42-1, 42-2 as a rotation axis. When the glass rod 43 rotates, a force acts on the glass rod 43 to return in the opposite direction to the rotation direction due to the gravitational force acting on the glass rod 43 (the deadweight of the glass rod 43). For example, the deadweight of the glass rod 43 is adjusted, and thereby, a pressing force when spreading by the glass rod 43 is performed (spreading force) may be adjusted and the force can be decreased or increased, or significantly decreased.

As described above, an end (e.g. the outer end) of the glass rod 43 can move relatively to an end of the second manipulator MNP2 (e.g. the part in which the second end effector END2 is provided).

Note that, in the embodiment, in view of the configuration of the second end effector END2, the glass rod 43 cannot rotate to 360 degrees. The rod moves like a pendulum, but does not make one revolution. The inside of the petri dish 82 can be swept by the rotation of the opposite end (the other end) to the end of the glass rod 43. The glass rod 43 is a member having a degree of freedom of motion in both directions in one rotation (motion like a pendulum) and can perform spreading by the motion (spreading member).

The glass rod 43 is an example of the spreading member and the spreading member may be formed using various materials in various shapes. Further, in the embodiment, the members for rotating the spreading member are provided, however, as another configuration, a configuration not rotating without the members for rotating the spreading member may be used.

FIG. 3 shows another example of a schematic configuration of a second end effector END2-1 of a robot according to one embodiment of the invention. FIG. 3 shows a petri dish 82 as an example of the container.

Differences of the second end effector END2-1 shown in FIG. 3 from the second end effector END2 shown in FIG. 2 will be explained. The same parts of the effectors may have the same signs.

In the second end effector END2-1 shown in FIG. 3, in addition to the two members 42-1, 42-2 facing each other, two members 101-1, 101-2 facing each other are provided on the same surface of the base member 41. A line connecting the two members 42-1, 42-2 facing each other and a line connecting the two members 101-1, 101-2 facing each other are orthogonal (nearly orthogonal) to each other. A spring 111-1 is connected to positions facing each other of the member 101-1 and the glass rod 43, and a spring 111-2 is connected to positions facing each other of the other member 101-2 and the glass rod 43. The two springs 111-1, 111-2 have linear shapes (or nearly linear shapes). According to the configuration, when the glass rod 43 rotates, a force to return in the opposite direction to the rotation direction acts on the glass rod 43 by changes (expansion and contraction) of the springs 111-1, 111-2. Thereby, a pressing force (spreading force) when spreading by the glass rod 43 is performed can be made stronger than that in the case where the springs 111-1, 111-2 are not provided. Note that, even in the case where the springs 111-1, 111-2 are provided, the gravitational force acting on the glass rod 43 (the deadweight of the glass rod 43) exists like that in the case without the springs 111-1, 111-2.

Here, in the embodiment, the second end effector END2 without springs as shown in FIG. 2 is used, however, as another configuration example, the second end effector END2-1 with the springs 111-1, 111-2 as shown in FIG. 3 may be used.

Or, as the other configuration examples, various overall configurations, materials, forms, arrangements, etc. of the respective parts of the second end effector END2 may be used.

The first end effector END1 of the robot 1 will be explained.

The first end effector END1 has a hand shape. In the embodiment, the hand is a hand in which four fingers 48-1 to 48-4 each having one joint are provided.

Note that, as the other configuration examples, various structures of the first end effector END1 may be used.

The processing apparatuses will be explained. The processing apparatuses are arranged within the movable range of the robot 1 (within the movable ranges of the manipulators MNP1, MNP2 in the embodiment).

The processing apparatuses to be grasped by the first end effector END1 will be explained.

In the embodiment, as the processing apparatuses, a holder 81 and the petri dish 82 are provided. The holder 81 integrally has two members 91-1, 91-2 that grasp the petri dish 82 in contact with both side surfaces thereof and a member 92 as a handle to be grasped by the first end effector END1.

The first end effector END1 grasps the holder 81, and thereby, the petri dish 82 grasped by the holder 81 can be held in a horizontal (or nearly horizontal) state or the like. In the embodiment, the first end effector END1 grasps the petri dish 82 via the holder 81.

Note that, as the container, another container than the petri dish 82 may be used.

The processing apparatuses to be placed will be explained.

As the processing apparatuses, a stand 71 and a test tube 72 are provided. The stand 71 has a mechanism that holds the test tube 72 from both sides and can vertically (or nearly vertically) hold the test tube 72. The diameter of the test tube 72 is larger than the diameter of the glass rod 43.

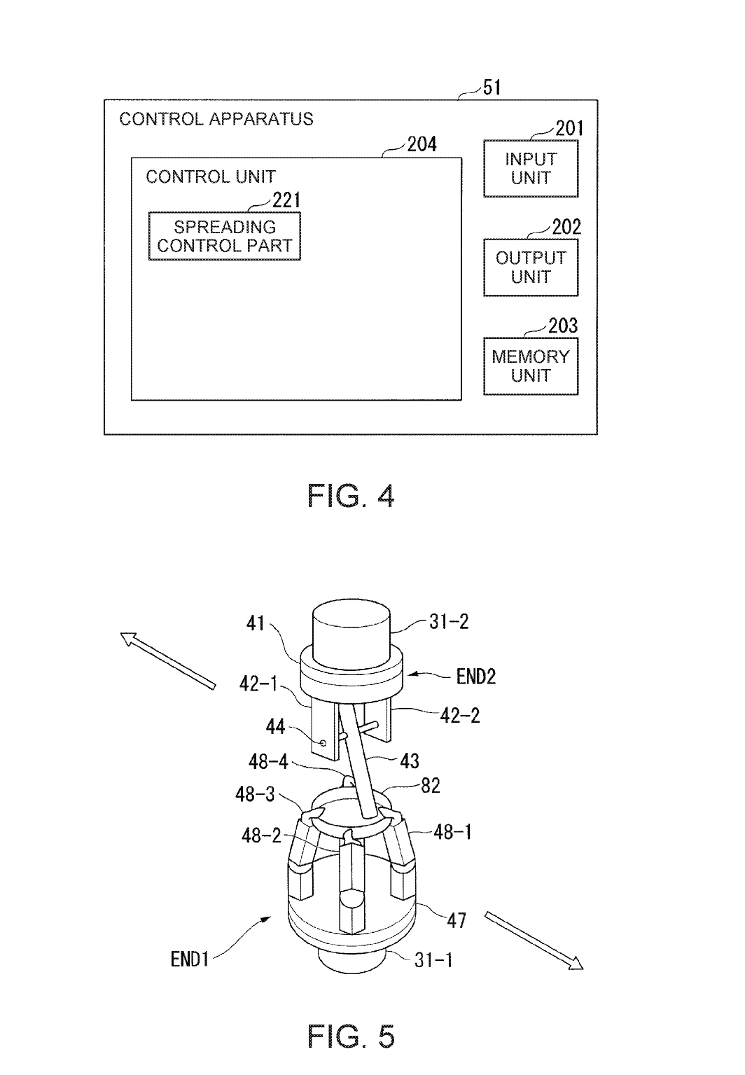

FIG. 4 is a block diagram showing a schematic configuration example of the control apparatus 51 according to one embodiment of the invention.

The control apparatus 51 includes an input unit 201, an output unit 202, a memory unit 203, and a control unit 204. The control unit 204 includes a spreading control part 221.

Information is externally input to the input unit 201. For example, the input unit 201 has an operation part to be operated by a user, and information in response to an operation of the operation part may be input or information output from an external apparatus may be input thereto.

The output unit 202 externally outputs information. For example, the output unit 202 has a display screen, and may output information to the display screen or output information to an external apparatus.

The memory unit 203 stores information. For example, the memory unit 203 stores a motion control program, various parameters, etc.

The control unit 204 performs various kinds of control on the robot 1. For example, the control unit 204 includes a processor such as a CPU (Central Processing Unit) and performs various kinds of control by executing the motion control program stored in the memory unit 203.

The spreading control part 221 performs control on spreading processing.

An example of the spreading processing performed under the control by the spreading control part 221 is shown.

In the embodiment, processing apparatuses for the dilution plate technique are used. Specifically, the test tube 72 contains a bacterium. Inside of the petri dish 82, agar (agar medium) to which the bacterium is to be rubbed is held in advance.

The robot 1 inserts the outer end (the above described other end) of the glass rod 43 of the second end effector END2 into the test tube 72 so that the bacterium (an example of a sample) may be attached to the outer end of the glass rod 43. Then, the robot 1 spreads the surface of the agar inside of the petri dish 82 with the outer end of the glass rod 43 of the second end effector END2. Thereby, the bacterium is rubbed over the surface of the agar inside of the petri dish 82.

As an example, the glass rod 43 applies a force to such an extent that the agar inside of the petri dish 82 is not destroyed.

Note that, in the embodiment, the bacterium inside of the test tube 72 is attached to the outer end of the glass rod 43, however, as another configuration example, the bacterium may be attached by applying the bacterium to the outer end of the glass rod 43 in advance.

Further, various objects may be used as objects to be spread over the agar, and e.g. various chemicals, various specimens, various bacteria, etc. may be used.

Furthermore, the robot 1 can perform work equivalent to the dilution plate technique (e.g. work of performing the same motions as those of the dilution plate technique).

Here, in the embodiment, the position and the attitude of the petri dish 82 are fixed without changing the positions and the attitudes of the first end effector END1 and the first manipulator MNP1 that grasp the holder 81 of the petri dish 82 and (either or both of) the positions and the attitudes of the second end effector END2 and the second manipulator MNP2 that grasp the glass rod 43 are changed to move the glass rod 43, and thereby, spreading is performed.

As another motion example, the positions and the attitudes of the second end effector END2 and the second manipulator MNP2 that grasp the glass rod 43 are fixed and (either or both of) the positions and the attitudes of the first end effector END1 and the first manipulator MNP1 that grasp the holder 81 of the petri dish 82 are changed to move the petri dish 82, and thereby, spreading may be performed. In this case, the glass rod 43 comes into contact with the surface of the agar inside of the petri dish 82, and is moved with the movement of the petri dish 82. In the embodiment, the petri dish 82 is moved with the motion of the first manipulator MNP1, and the end (e.g. the outer end) of the glass rod 43 in contact with the agar inside of the petri dish 82 moves.

As another motion example, (either or both of) the positions and the attitudes of the second end effector END2 and the second manipulator MNP2 that grasp the glass rod 43 are changed to move the glass rod 43 and (either or both of) the positions and the attitudes of the first end effector END1 and the first manipulator MNP1 that grasp the holder 81 of the petri dish 82 are changed to move the petri dish 82, and thereby, spreading may be performed.

Or, the robot 1 can spread the inside of the petri dish 82 in cross directions with the outer end of the glass rod 43. For example, the robot 1 moves the outer end of the glass rod 43 in both directions in single rotation like a pendulum with respect to the petri dish 82, then, moves either or both of the glass rod 43 and the petri dish 82 so that their relative position relationship may be changed and the direction of the rotation of the glass rod 43 may be changed to 90 degrees, and thereby, moves the outer end of the glass rod 43 in both directions in the other rotation like a pendulum with respect to the petri dish 82. That is, the direction of the first pendulum and the direction of the second pendulum are orthogonalized (or nearly orthogonalized), and collectively, spreading in the cross directions may be performed.

As described above, the robot 1 according to the embodiment may spread chemicals or the like in the medical field or the like. For example, the robot 1 can perform spreading work without destroying the agar inside of the petri dish 82. In the embodiment, spreading work using the petri dish 82 by a human or work equivalent thereto can be replaced with work performed by an industrial robot.

The robot 1 according to the embodiment has the mechanism that can freely move the glass rod 43 supported by the supporting portions 44 in both directions of one rotation with respect to the arm (in the embodiment, the second end effector END2). In the embodiment, the mechanism does not necessarily have motive power of a motor or the like. As described above, a spreading force (pressing force) by the glass rod 43 can be made constant (or nearly constant) by the mechanism that provides the degree of freedom in both directions of one rotation to the glass rod 43 for spreading.

Generally, it is very difficult to control the end of the robot arm to accurately move in one direction in the real space, however, the motion can be easily made using the mechanism of the second end effector END2 according to the embodiment.

Note that, in the robot 1 according to the embodiment, impedance control may be performed or not with respect to the motions of the respective manipulators MNP1, MNP2. The impedance control on the respective manipulators MNP1, MNP2 is performed based on detection values of the respective force sensors 31-1, 31-2 attached to the respective manipulators MNP1, MNP2. The impedance control is performed, and thereby, errors in the real work performed by the robot 1 (differences from theory) can be flexibly addressed.

Here, in the embodiment, the case where the glass rod 43 and the members for rotating the glass rod 43 are integrated with the second end effector END2 is shown. As another configuration example, the same hand as the first end effector END1 may be used as the second end effector END2 and the glass rod 43 and a processing apparatus (e.g. jig) having the members for rotating the glass rod 43 may be grasped by the second end effector END2.

### Second Embodiment

The explanation will be made with reference to the robot 1 shown in FIG. 1. In the embodiment, differences from the first embodiment will be explained in detail and the explanation of the same parts will be simplified or omitted. Further, in the embodiment, the same configuration parts as those of the first embodiment have the same signs.

The robot 1 according to the embodiment grasps the petri dish 82 by the fingers 48-1 to 48-4 of the first end effector END1 of the first manipulator MNP1.

The configuration and the motion of the second end effector END2 of the second manipulator MNP2 are the same as those of the first embodiment.

FIG. 5 shows an example of a spreading motion performed by the robot 1 according to one embodiment of the invention. Here, a direction in which an attracting force acts due to gravity and pulls is referred to as “vertically downward” and the opposite direction is referred to as “vertically upward”.

The four fingers 48-1 to 48-4 of the first end effector END1 come into contact with the side surface of the petri dish 82 and grasp and hold the petri dish 82 so that the surface inside of the petri dish 82 may face vertically upward (or nearly vertically upward). In the example of FIG. 5, the petri dish 82 is supported by the four fingers 48-1 to 48-4 from the side vertically downward with respect to the petri dish 82.

Further, the outer end of the glass rod 43 of the second end effector END2 is held to face vertically downward (or nearly vertically downward) in the free state, and the outer end of the glass rod 43 is held in contact with the agar inside of the petri dish 82.

Then, the first manipulator MNP1 and the second manipulator MNP2 are moved so that the first end effector END1 and the second end effector END2 may move (e.g. reciprocate) in horizontal directions orthogonal to the vertical directions and opposite to each other. Thereby, the outer end of the glass rod 43 may be swept on the agar inside of the petri dish 82.

In the example of FIG. 5, the second end effector END2 having the glass rod 43 and the first end effector END1 having the petri dish 82 are moved in opposite directions to each other (as an example, directions of arrows shown in FIG. 5). Thereby, equal work to that in the case where one of the two end effectors END1, END2 is moved may be realized and, in linear moving motion in the real space that has been considered to be difficult for the robot, the amount of movement can be reduced to half compared to the case where only one of the end effectors is moved. Note that, in the arrangement in the example of FIG. 5, a motion of moving one of the two end effectors END1, END2 may be performed.

Here, in the embodiment, in the case where the first manipulator MNP1 and the first end effector END1 grasp the petri dish 82, in addition to the motion of fixing the petri dish 82, a motion of rotating the petri dish 82, a motion of linearly moving the petri dish 82, and a motion of inclining the petri dish 82 can be performed. Each of these motions may be realized by e.g. a motion of arbitrary one of the first manipulator MNP1 and the first end effector END1 or realized by motions of both. In the embodiment, the petri dish 82 may be moved with the motion of the first manipulator MNP1, and the end (e.g. the outer end) of the glass rod 43 in contact with the agar inside of the petri dish 82 moves.

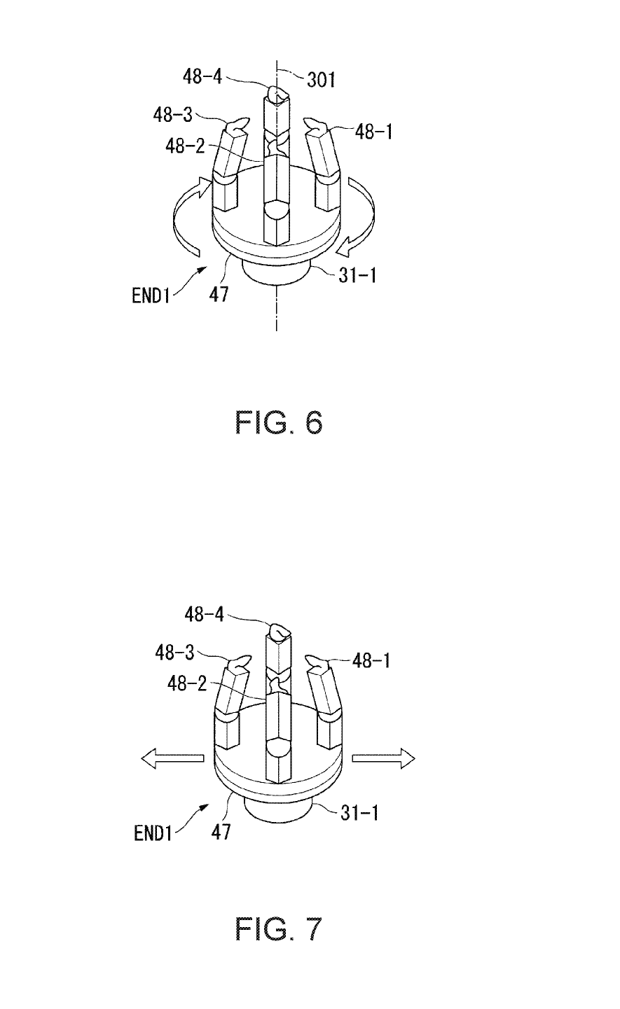

FIG. 6 shows an image of rotation of the first end effector END1 according to one embodiment of the invention.

In the embodiment, a base member 47 of the first end effector END1 has a circular plate shape (or cylindrical shape), and one surface is connected to the first manipulator MNP1 and the four fingers 48-1 to 48-4 are provided on the other surface. In the first end effector END1, the base member 47 and the fingers 48-1 to 48-4 can rotate about an axis (rotation center axis 301) perpendicular to the surface of the base member 47 (in the example of FIG. 5, the horizontal surface) as a center axis. Thereby, in the first end effector END1, the petri dish 82 can be rotated about an axis perpendicular to a bottom surface (or upper surface) of the base member 47 while the petri dish 82 is grasped.

As an example, when grasping the petri dish 82, the first manipulator MNP1 and the first end effector END1 can rotate the petri dish 82 about an axis perpendicular to a bottom surface of the petri dish 82. In this case, in the embodiment, the petri dish 82 is grasped in a state in which the bottom surface of the petri dish 82 and the bottom surface (or upper surface) of the base member 47 are in parallel (or nearly in parallel). Here, FIG. 6 shows an example of a rotation direction by arrows, and an opposite rotation direction may be used as another example.

Note that the rotating motion is performed by the control unit 204 of the control apparatus 51 controlling one or both of the first manipulator MNP1 and the first end effector END1. The rotating motion may be realized by the rotation mechanism provided in the first end effector END1, realized by the motion of the first manipulator MNP1, or realized by both motions.

FIG. 7 shows an image of linear movement of the first end effector END1 according to one embodiment of the invention.

In the first end effector END1, the petri dish 82 can be moved at least in one linear direction (as an example, in a direction of an arrow shown in FIG. 7) in parallel to the surface of the base member 47 (in the example of FIG. 5, the horizontal surface). Thereby, in the first end effector END1, the petri dish 82 can be linearly moved in parallel to the bottom surface (or upper surface) of the base member 47 while the petri dish 82 is grasped.

Note that the moving motion is performed by the control unit 204 of the control apparatus 51 controlling one or both of the first manipulator MNP1 and the first end effector END1. The moving motion may be realized by the moving mechanism provided in the first end effector END1, realized by the motion of the first manipulator MNP1, or realized by both motions.

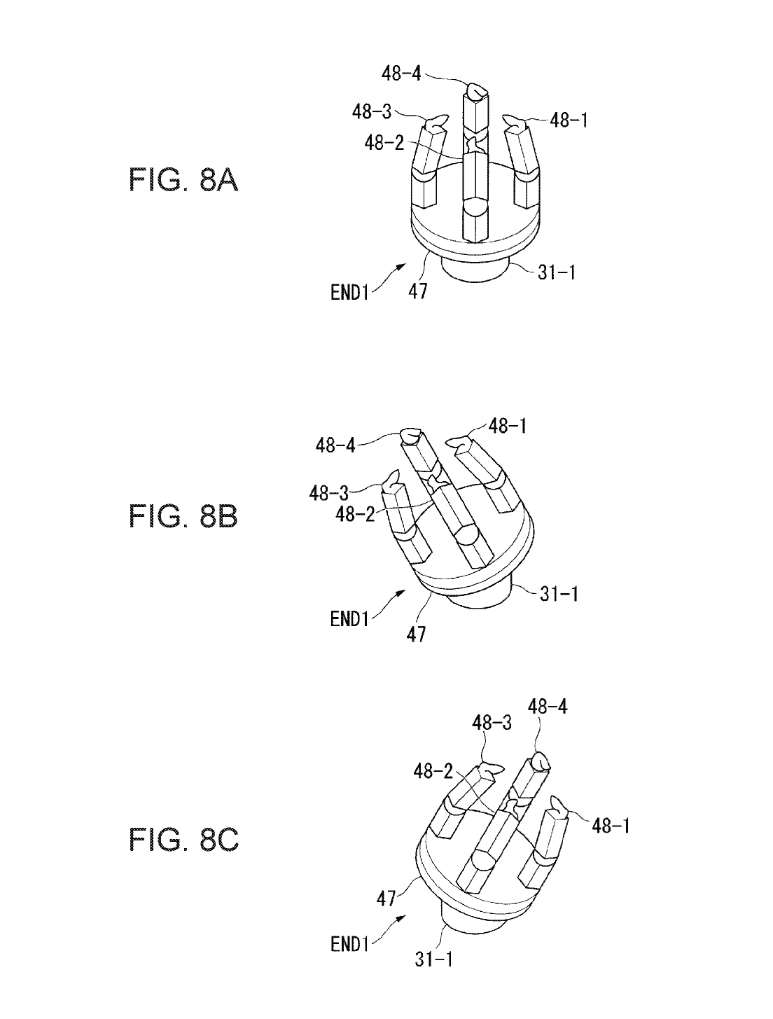

FIGS. 8A, 8B, 8C show images of inclinations of the first end effector END1 according to one embodiment of the invention.

In the first end effector END1, the surface of the base member 47 (in the example of FIG. 5, the horizontal surface) can be inclined. Thereby, in the first end effector END1, the petri dish 82 can be inclined while the petri dish 82 is grasped.

FIG. 8A shows the case where an axis perpendicular to the surface of the base member 47 indicates vertically upward in the first end effector END1 like the example in FIG. 5.

FIGS. 8B and 8C respectively show the cases where the base member 47 and the fingers 48-1 to 48-4 have inclination angles with respect to the example in FIG. 8A in the first end effector END1. The example in FIG. 8B and the example in FIG. 8C respective show examples in which the base member 47 inclines in different directions. In the embodiment, the petri dish 82 has a circular plate shape (or cylindrical shape) and the center axis of the surface of the petri dish 82 can be inclined.

Note that the inclining motion is performed by the control unit 204 of the control apparatus 51 controlling one or both of the first manipulator MNP1 and the first end effector END1. The inclining motion may be realized by the inclining mechanism provided in the first end effector END1, realized by the motion of the first manipulator MNP1, or realized by both motions.

As described above, the robot 1 according to the embodiment may spread chemicals or the like in the medical field or the like.

### Third Embodiment

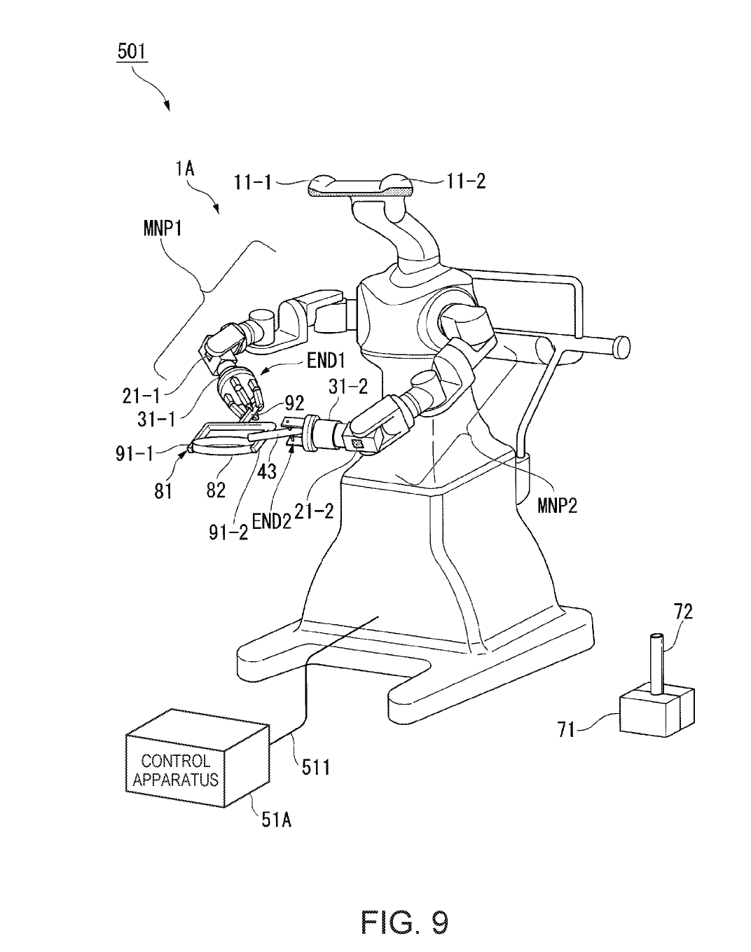

FIG. 9 shows a schematic configuration example of a robot system 501 according to one embodiment of the invention.

In FIG. 1, the configuration example in which the control apparatus 51 is provided within the robot 1 is shown, and, in the embodiment, a configuration example in which a control apparatus 51A and a robot 1A (a main body except the control apparatus) are separately provided is shown.

The robot system 501 includes the robot 1A, the control apparatus 51A, and a line 511. The line 511 may be a wired line or wireless line.

The robot 1A and the control apparatus 51A are communicably connected via the line 511 and communicate various kinds of information. The robot 1A has the same configuration as the robot 1 shown in FIG. 1 except that the control apparatus 51A is separately provided, and the same configuration parts have the same signs. Further, the control apparatus 51A has the same function as the control apparatus 51 shown in FIG. 4 except that the apparatus is separately provided from the robot 1A. Thereby, in the robot system 501, various motions are performed like the robot 1 shown in FIG. 1.

### Fourth Embodiment

In the embodiment, a single-arm robot will be explained. Note that the explanation will be made using the same signs as those in the explanation of the dual-arm robot.

As an example, as a single-arm configuration, a robot that has the same configurations as those of the first manipulator MNP1 and the first end effector END1 shown in FIG. 1 (here, for convenience of explanation, called first manipulator MNP1 and first end effector END1) and performs the same motions may be embodied. In this case, the glass rod 43 and a processing apparatus (e.g. jig) having the members for rotating the glass rod 43 are placed in e.g. a work space of the robot. Further, spreading on the agar inside of the petri dish 82 grasped by the first end effector END1 of the robot is performed by the glass rod 43. The robot changes e.g. (either or both of) the positions and the attitudes of the first end effector END1 and the first manipulator MNP1. The glass rod 43 and the processing apparatus (e.g. jig) having the members for rotating the glass rod 43 may be fixed to e.g. a ceiling or the like or movable in a direction as explained in FIG. 5. In the embodiment, the petri dish 82 is moved with the motion of the first manipulator MNP1, and the end (e.g. the outer end) of the glass rod 43 in contact with the inside of the petri dish 82 moves.

As another example, as the single-arm configuration, a robot that has the same configurations as those of the second manipulator MNP2 and the second end effector END2 shown in FIG. 1 (here, for convenience of explanation, called second manipulator MNP2 and second end effector END2) and performs the same motions may be embodied. In this case, the petri dish 82 is placed in e.g. a work space of the robot. Further, spreading on the agar inside of the petri dish 82 is performed by the glass rod 43 of the second end effector END2 of the robot. The robot changes e.g. (either or both of) the positions and the attitudes of the second manipulator MNP2 and the second end effector END2. The petri dish 82 may be fixed to e.g. a table or the like or movable in a direction as explained in FIG. 5.

### Outline of Embodiments

One configuration example is the robot (in the above described embodiments, the robot 1, 1A) including the first arm (in the above described embodiments, the first manipulator MNP1) and the first end effector END1 provided in the first arm, and the container (in the above described embodiments, the petri dish 82) is grasped by the first end effector END1 and an object (in the above described embodiments, a bacterium) is spread within the container by the spreading member (in the above described embodiments, the glass rod 43).

As one configuration example, the robot includes the second arm (in the above described embodiments, the second manipulator MNP2).

As one configuration example, the robot includes the second end effector END2 provided in the second arm, and the spreading member is grasped by the second end effector END2.

As one configuration example, the robot includes the second end effector END2 provided in the second arm and the second end effector END2 includes the spreading member.

As one configuration example, in the robot, the end of the spreading member is movable relatively to the end of the second arm.

As one configuration example, in the robot, the spreading member applies a force to such an extent that an agar medium is not destroyed.

As one configuration example, in the robot, work of a dilution plate technique or work equivalent thereto can be performed.

As one configuration example, in the robot, when the first armor the first end effector END1 grasps the container, the container can be rotated about the axis perpendicular to the bottom surface of the container.

As one configuration example, in the robot, the end of the spreading member moves with the motion of the first arm.

One configuration example is the control apparatus 51, 51A that performs control of grasping the container by the first end effector END1 of the robot including the first arm and the first end effector END1 provided in the first arm and spreading an object within the container using the spreading member.

One configuration example is a control method (in the above described embodiments, a control method performed in the control apparatus 51, 51A) of performing control of grasping the container by the first end effector END1 of the robot including the first arm and the first end effector END1 provided in the first arm and spreading an object within the container using the spreading member.

As above, the embodiments of the invention are described in detail with reference to the drawings, however, the specific configurations are not limited to the embodiments and include designs etc. without departing from the scope of the invention.

Note that a program for realizing a function of an arbitrary configuration part in the above described apparatus (e.g. the control apparatus 51, 51A) may be recorded (stored) in a computer-readable recording medium (memory medium) and the program may be read into a computer system and executed. Note that “computer system” here includes an operating system (OS) or hardware such as a peripheral. Further, “computer-readable recording medium” refers to a portable medium such as a flexible disk, a magnetooptical disk, a ROM (Read Only Memory), a CD (Compact Disk)-ROM and a storage device such as a hard disk built in the computer system. Furthermore, “computer-readable recording medium” includes a medium that holds a program in a fixed period such as a volatile memory (RAM: Random Access Memory) within the computer system serving as a server or client when the program is transmitted via a network such as the Internet or a communication line such as a phone line.

The program may be transmitted from the computer system in which the program is stored in a memory device or the like via a transmission medium or transmission wave within the transmission medium to another computer system. Here, “transmission medium” for transmission of the program refers to a medium having a function of transmitting information such as a network (communication network) such as the Internet or a communication line such as a phone line.

Further, the program may realize part of the above described functions. Furthermore, the program may realize the above described functions in combination with a program that has been already recorded in the computer system, the so-called differential file (differential program).

The entire disclosure of Japanese Patent Application No. 2015-120868, filed Jun. 16, 2015 is expressly incorporated by reference herein.

What is claimed is:

1. A robot comprising:
a first arm; and
a first end effector provided in the first arm,
wherein the first end effector grasps a container and an object is spread within the container using a spreading member.

2. The robot according to claim 1, further comprising a second arm.

3. The robot according to claim 2, further comprising a second end effector provided in the second arm,
wherein the second end effector grasps the spreading member.

4. The robot according to claim 2, further comprising a second end effector provided in the second arm,
wherein the second end effector includes the spreading member.

5. The robot according to claim 3, wherein an end of the spreading member is movable relatively to an end of the second arm.

6. The robot according to claim 1, wherein the spreading member applies a force to such an extent that an agar medium is not destroyed.

7. The robot according to claim 1, wherein work of a dilution plate technique or work equivalent thereto can be performed.

8. The robot according to claim 1, wherein, when the first arm or the first end effector grasps the container, the container can be rotated about an axis perpendicular to a bottom surface of the container.

9. The robot according to claim 1, wherein an end of the spreading member moves with a motion of the first arm.

10. A control apparatus of a robot including a first arm and a first end effector provided in the first arm, the control apparatus performing control of grasping a container by the first end effector and spreading an object within the container using a spreading member.

11. A control method of a robot including a first arm and a first end effector provided in the first arm, the method comprising:
performing control of grasping a container by the first end effector and spreading an object within the container using a spreading member.
